(19) United States
(12) Patent Application Publication
(10) Pub. No.: US 2025/0347953 A1
(43) Pub. Date: Nov. 13, 2025

(54) DISPLAY DEVICE AND DISPLAY SYSTEM

(71) Applicant: Sharp Display Technology Corporation, Kameyama City (JP)

(72) Inventors: Masamitsu KOBAYASHI, Kameyama City (JP); Takafumi MIURA, Kameyama City (JP)

(21) Appl. No.: 19/201,058

(22) Filed: May 7, 2025

(30) Foreign Application Priority Data
May 10, 2024 (JP) 2024-077142

(51) Int. Cl. G02F 1/1335; G09G 3/34; G09G 3/36

(52) U.S. Cl. CPC G02F 1/133541; G09G 3/3692; G09G 3/342; G09G 2320/0285

(57) ABSTRACT

A display device includes a display panel, a polarizing module placed over a screen of the display panel, and a control unit. The control unit sequentially generates an interpolated image by a frame interpolation process from two consecutive frames of the data for the first image and, from the interpolated image thus generated, generates an reverse image of the interpolated image as a second image. The control unit causes the first image and the second image to be displayed by time division. The control unit controls the polarizing module so that a state of polarization of the polarizing module is a first state of polarization during a period of display of the first image and is a second state of polarization during a period of display of the second image in synchronization with a timing of the time division.

### BACKGROUND

### 1. Field

The present disclosure relates to a display device and a display system.

### 2. Description of the Related Art

Flat-panel displays such as liquid crystal displays and organic EL displays are used in various types of device such as laptop PCs, mobile devices such as smartphones, and vehicles' instrument panels. In some cases, these devices display secret information, private information, or other information on the screen and are used so that only a particular person is allowed to visually recognize the information and another person is not allowed to recognize the information. For example, Japanese Patent No. 5299275 discloses an image processing device that allows only a user who looks at a display to view a secret image using shutter-equipped glasses.

In a case where the secret image is a moving image, a conventional image processing device undesirably makes it easy for the secret image to be recognized by another person. It is desirable to provide a display device and a display system that, even in a case where a secret image is a moving image, makes it hard for the secret image to be visually recognized by another person.

### SUMMARY

According to an aspect of the disclosure, there is provided a display device including a display panel, a polarizing module placed over a screen of the display panel and configured to actively switch between causing light emitted from the screen of the display panel to be transmitted in a first state of polarization and causing the light to be transmitted in a second state of polarization, and a control unit. The control unit sequentially receives data for a first image from an outside source. The control unit sequentially generates an interpolated image by a frame interpolation process from two consecutive frames of the data for the first image and, from the interpolated image thus generated, generates an reverse image of the interpolated image as a second image. The control unit causes the first image and the second image to be displayed by time division. The control unit controls the polarizing module so that a state of polarization of the polarizing module is the first state of polarization during a period of display of the first image and is the second state of polarization during a period of display of the second image in synchronization with a timing of the time division.

### BRIEF DESCRIPTION OF THE DRAWINGS

FIG. 1 is a schematic configuration diagram of a display system of a first embodiment;

FIG. 2 shows an example of a look-up table;

FIG. 3 is a schematic view explaining operation of an image generation circuit;

FIG. 4 is a schematic view showing a state of polarization of a polarizing module, display of images on a liquid crystal display panel, and timings of turning on of a backlight;

FIG. 5 is a schematic view explaining an image that a first viewer visually recognizes;

FIG. 6 is a schematic view explaining an image that a second viewer visually recognizes;

FIG. 7A is a schematic view obtained by extracting first rows of pixels from frame images of a first image and a second image that reach the second viewer and longitudinally arranging them on top of each other along a time axis;

FIG. 7B is a schematic view obtained by extracting first rows of pixels from frame images of a first image and a second image that reach the second viewer and longitudinally arranging them on top of each other along a time axis;

FIG. 8 is a schematic configuration diagram of a display system of a second embodiment; and

FIG. 9 is a schematic view showing a state of polarization of a polarizing module, display of images on a liquid crystal display panel, and timings of turning on of a backlight.

### DESCRIPTION OF THE EMBODIMENTS

Embodiments of the present disclosure are described below with reference to the drawings. The present disclosure is not limited to the following embodiments but can be designed and changed as appropriate as far as a configuration of the present disclosure is fulfilled. Further, in the following description, identical components or components having similar functions are given identical reference signs in common throughout different drawings, and a repeated description of such components may be omitted. Further, configurations described in the embodiments and modifications may be combined or may be changed as appropriate without departing from the scope of the present disclosure. For ease of understanding of explanation, the drawings to be referred to below may show configurations in a simplistic form or in a schematic form or may omit some constituent members. Further, dimensional ratios between constituent members shown in the drawings do not necessarily represent actual dimensional ratios.

### First Embodiment

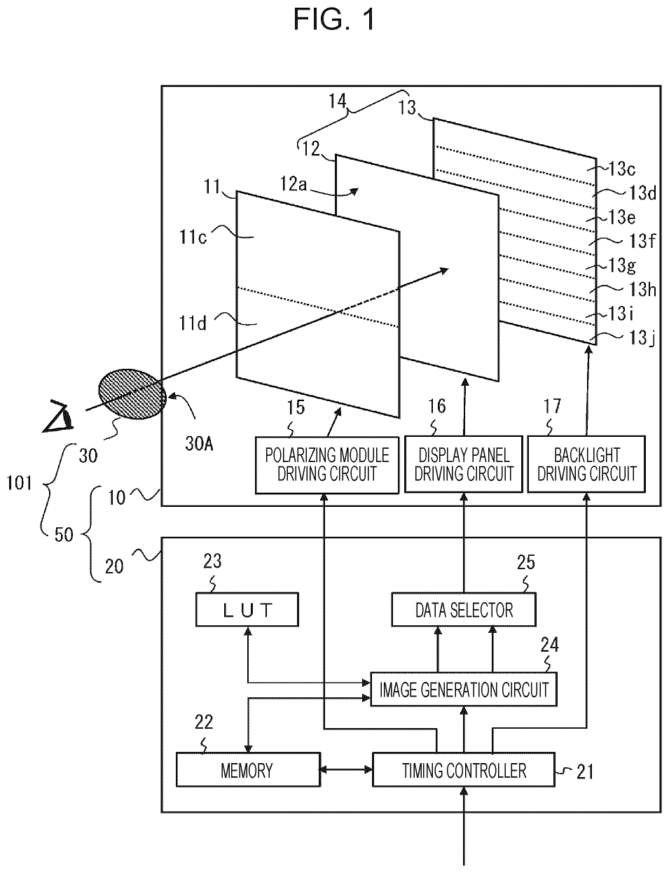

FIG. 1 is a schematic configuration diagram of a display system 101 of the present embodiment. The display system 101 includes a display device 50 and glasses 30. The display device 50 is mounted, for example, in a smartphone, a tablet terminal, a smartwatch, an on-board information display, a laptop personal computer, a personal computer, a monitor for use in a personal computer, a television, or other devices. The display device 50 includes a polarized display panel 10 and a control unit 20. Further, the polarized display panel 10 includes a polarizing module 11 and a display panel 14.

As will be described in detail below, the display panel 14 alternately displays a first image and a second image on a screen 12a by time division, and the polarizing module 11 comes into a first state of polarization when the first image is displayed in synchronization with a timing of the time division and comes into a second state of polarization when the second image is displayed in synchronization with the timing of the time division. Examples of the first state of polarization and the second state of polarization include linear polarizations whose transmission axes are orthogonal to each other and circular polarizations whose directions of rotation are different from each other.

The control unit 20 generates the second image, which is a reverse image, from the first image, which is a secret image that is presented to a first viewer. The first image is, for example, a moving image. The second image is not a reverse image of each frame of the first image but a reverse image of an interpolated image generated by a frame interpolation process from two consecutive frames of data for the first image.

With a polarizing plate 30A placed in the first state of polarization, the glasses 30 selectively transmit only the first image in the first state of polarization. For this reason, the first viewer, who is wearing the glasses 30, visually recognizes only the first image, which is the secret image.

Meanwhile, the second viewer, who does not wear the glasses 30, is presented with the first image and the second image. time integration effect of vision causes the second viewer to visually recognize, as the public image, a composite image made up of the first image and the second image. At this point in time, due to the action of head tracking, once the second viewer visually recognizes the first image, the second viewer's line of sight tracks the movement of the first image, so that the second viewer visually recognizes the edges of the first image with emphasis. For this reason, when presented with the second image, the second viewer perceives an interpolated image of the first image, although the interpolated image is not presented in actuality. As a result of that, the interpolated image thus perceived and the second image are combined to cancel each other out, so that the second viewer perceives a uniform gray image.

The following describes the display system 101 in detail. The display panel 14 may be a liquid crystal panel or may be a self-luminous panel such as an organic EL panel or a nano-LED panel, or a mini-LED panel. In the present embodiment, the display panel 14 includes a liquid crystal display panel 12 and a backlight 13. The liquid crystal display panel 12 can be driven by any driving system, and liquid crystal display panels that are driven by various types of driving system can be used. In a case where the display device 50 is mounted in a device configured to perform a wide viewing angle image display, a liquid crystal display panel that is driven in a transverse electric field mode such as FFS or IPS is suitably used.

The display panel 14 includes a plurality of pixels two-dimensionally arranged in a row-wise direction and a column-wise direction, a plurality of scanning lines, and a plurality of data lines. The plurality of scanning lines each extend in the row-wise direction and are arrayed in the column-wise direction. The plurality of data lines each extend in the row-wise direction and are arrayed in the column-wise direction. Since the column-wise direction is a direction in which the plurality of scanning lines are scanned, the column-wise direction is hereinafter called a “scanning direction”. Each pixel includes a pixel electrode and a TFT, and one of the plurality of scanning lines and one of the plurality of data lines are connected to a gate electrode and a source electrode, respectively, of the TFT of the pixel. Further, in each pixel, the pixel electrode is connected to a drain electrode of the TFT.

In the present embodiment, the backlight 13 is a partially drivable backlight. The backlight 13 may be of a direct type or may be of an edge type as long as it is partially drivable. The backlight 13 is, for example, a scanning backlight having a plurality of light sources that can be individually controlled. The light sources are, for example, LEDs (light-emitting diodes). The turning on and turning off of each of the plurality of light sources of the backlight 13 are individually controlled by the after-mentioned backlight driving circuit 17.

The backlight 13 can be controlled by the backlight driving circuit 17 to emit the same amount of light during both a period of display of the first image on the display panel 14 and a period of display of the second image on the display panel 14 or emit different amounts of light that vary between the period of display of the first image on the display panel 14 and the period of display of the second image on the display panel 14. For example, the backlight 13 can emit different amounts of light by varying the length of a period of glowing and/or the luminance of the light sources during glowing between the period of display of the first image on the display panel 14 and the period of display of the second image on the display panel 14. This makes it possible to appropriately regulate, according to characteristics such as conditions of response of the liquid crystal display panel 12 and the polarizing module 11, the amounts of light that are emitted from the backlight 13 during the period of display of the first image and the period of display of the second image, making it possible to further stabilize the luminance of an image that is displayed on the liquid crystal display panel 12.

Further, as shown in FIG. 1, the backlight 13 is divided into areas in a direction along the scanning lines of the liquid crystal display panel 12, can be kept turned off for a predetermined period of time since the start of writing of data for the first image or data for the second image, and can be turned on thereafter. As will be mentioned later, in the present embodiment, the timings of tuning on and turning off are varied between the period of display of the first image and the period of display of the second image. Although, in the example shown in FIG. 1, the backlight 13 is divided into eight areas 13c to 13j in the direction along the scanning lines, the backlight 13 may be divided into more than eight areas or may be divided into less than eight areas.

The polarizing module 11 is an active retarder configured to actively switch between causing light emitted from the screen 12a of the display panel 14 to be transmitted in the first state of polarization and causing the light to be transmitted in the second state of polarization. As mentioned above, the first state of polarization and the second state of polarization are, for example, linearly polarizations whose transmission axes are orthogonal to each other or circular polarizations one of which is a right-handed circular polarization and the other of which is a left-handed circular polarization.

In the present embodiment, the polarizing module 11 can independently control states of polarization in areas 11c and 11d into which the polarizing module 11 is divided in the scanning direction. Instead of being divided into two areas in the scanning direction, the polarizing module 11 may be divided into more than two areas or may be one area. Such a polarizing module 11 is used, for example, as a 3D image display technology or other technologies and can be implemented as an optical structure that switches between states of polarization using liquid crystal cells. Specifically, such a polarizing module 11 can be fabricated by using technologies disclosed, for example, in Japanese Unexamined Patent Application Publication No. 2023-104136, Japanese Unexamined Patent Application Publication No. 2023-107192, Japanese Unexamined Patent Application Publication No. 2023-157668, Japanese Unexamined Patent Application Publication No. 2024-008540, Japanese Patent Application No. 2022-206835, or other patent documents.

The polarized display panel 10 further includes a polarizing module driving circuit 15, a display panel driving circuit 16, and the backlight driving circuit 17. The polarizing module driving circuit 15 receives a synchronization signal from the control unit 20 and, in accordance with the synchronization signal, actively switches the states of polarization in the areas 11c and 11d of the polarizing module 11 between the first state of polarization and the second state of polarization.

The display panel driving circuit 16 receives an image signal and a start signal from the control unit 20, generates a scanning signal from the start signal, and generates a data signal from the image signal. The scanning lines are scanned by the scanning signal being applied to the scanning lines in sequence, and TFTs connected to the scanning lines become turned on. The data signal is applied to the data lines, and the data signal is applied to pixels whose TFTs are on.

The backlight driving circuit 17 receives the synchronization signal from the control unit 20 and, in accordance with the synchronization signal, selectively turns on the areas 13c to 13j of the backlight 13 in sequence in the scanning direction.

The glasses 30 are worn by the first viewer, who is supposed to visually recognize the secret image. The polarizing plate 30A is placed in the first state of polarization on a surface of the glasses 30. As mentioned above, the first state of polarization is a linear polarization or a circular polarization. The glasses 30 are not an active retarder, and there is no change in a state of polarization of the glasses 30. This makes it possible to make the glasses 30 simple in configuration.

Since the glasses 30 are worn by the first viewer, when the posture or head of the first viewer becomes tilted, the posture of the glasses 30 becomes tilted accordingly. As a result of that, in a case where the first state of polarization and the second state of polarization are linear polarizations, the transmission axis of the first state of polarization of the glasses 30 worn by the first viewer becomes non-parallel with the transmission axis of the first state of polarization presented by the polarized display panel 10, so that it becomes hard to visually recognize the secret image. In this case, the first viewer can increase viewability by changing the tilt of the heard in such a direction that it becomes easier to view the secret image. Further, in a case where the first state of polarization and the second state of polarization are circular polarizations, the first viewer can visually recognize the secret image without being affected by the posture of the glasses 30.

The control unit 20 includes a timing controller 21, a memory 22, a look-up table (LUT) 23, an image generation circuit 24, and a data selector 25.

The timing controller 21 receives, from an outside source, an image signal containing the data for the secret image, which is the first image, and stores the data for the secret image in the memory 22. The timing controller 21 further generates a synchronization signal from the image signal and outputs the synchronization signal to the polarizing module driving circuit 15 and the backlight driving circuit 17.

The look-up table 23 includes a data set that is referred to so that the data for the second image is generated from the interpolated image of the first image. The look-up table 23 is stored, for example, in a nonvolatile memory such as an EPROM or an EEPROM.

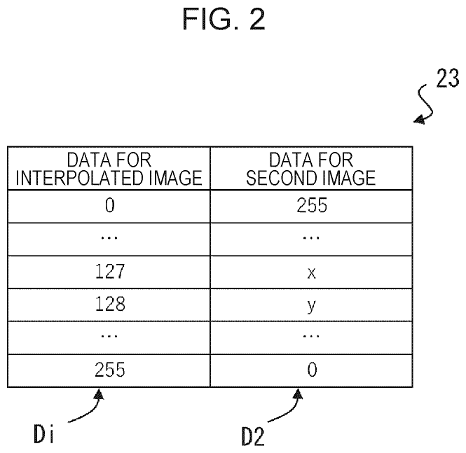

FIG. 2 shows an example of the look-up table 23. In the present embodiment, the look-up table 23 includes a data set in which luminance tone values D2 of the second image are associated with luminance tone values Di of the interpolated image of the first image. For example, in a case where the display panel 14 is compatible with eight bits and a 256-step gradation, the second image has a luminance tone value D2 of 255 when the interpolated image has a luminance tone value Di of 0, and the second image has a luminance tone value D2 of 0 when the interpolated image has a luminance tone value Di of 255. In FIG. 2, the second image has luminance tone values D2 of x and y when the interpolated image has luminance tone values Di of 127 and 128, respectively. x and y may be 128 and 127, respectively, or may assume other values.

In a case where the display panel 14 is a high-response-speed panel such as an organic EL panel, the luminance tone values Di and the luminance tone values D2 of the second image often satisfy color reversal relationships with each other when obtained by calculation. Meanwhile, in a case where the display panel 14 is a liquid crystal display panel, it may take time for liquid crystal molecules to respond. Further, in particular, the liquid crystal display panel is known to take time to respond from one neutral color to another. In such a case, the look-up table 23 may be determined by actually driving the display panel 14 and obtaining the luminance tone values Di and the luminance tone values D2 by measurement.

More specifically, first, either all over the display panel 14 or in an area sufficient to perform a luminance measurement, the luminance of the display panel 14 is measured with the display 14 driven under a first condition where a time-division display is performed at the minimum luminance tone value (0) during a period (first period, which will be described below) during which to display the first image and at the maximum luminance tone value (255) during a period (second period) during which to display the second image. Next, a luminance tone value D2 at which the same luminance is attained as in the case of the first condition is searched for while changing a luminance tone value Di of glowing during the period during which to display the first image. This is repeated to obtain all combinations of a luminance tone value Di and a luminance tone value D2.

Alternatively, the look-up table 23 may include, as data, only some of all combinations of a luminance tone value Di and a luminance tone value D2, and the image generation circuit 24 may be configured to obtain other combinations by computation such as interpolation. Furthermore, the control unit 20 may include a look-up table 23 for each color of RGB, and the look-up table 23 may be used in common for each color of RGB.

In a case where the display panel 14 is a liquid crystal display panel, the display responsiveness can vary with temperature. For this reason, the control unit 20 may include a plurality of look-up tables 23 created based on measurements performed at different temperatures. In this case, the control unit 20 may further include a temperature sensor or other devices, and based on ambient temperature measured by the temperature sensor, the control unit 20 may select one of the plurality of look-up tables 23 for use.

The image generation circuit 24 sequentially receives the data for the first image from the memory 22 and sequentially generates an interpolated image by a frame interpolation process from two consecutive frames of the data for the first image. Furthermore, from the interpolated image thus generated, the image generation circuit 24 generates a reverse image of the interpolated image as the second image with reference to the look-up table 23. The memory 22 stores only one immediately preceding frame of the data for the first image, and the image generation circuit 24 may receive a current frame of data from the timing controller 21 and generate an interpolated image.

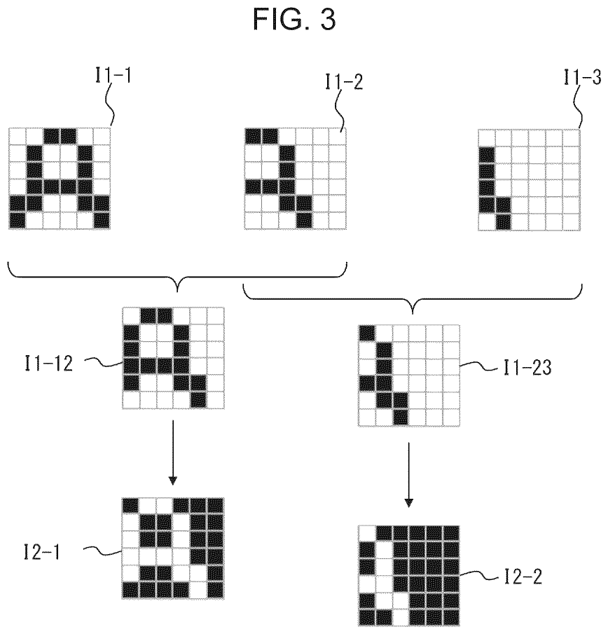

FIG. 3 is a schematic view explaining the aforementioned operation of the image generation circuit 24. For example, the data for the first image received from the memory 22 includes, for example, frames images I1-1, I1-2, and I-3 of the first image, and the image generation circuit 24 generates an interpolated image I1-12 by a frame interpolation process from the frame image I1-1 and the frame image I1-2 and generates an interpolated image I1-23 by a frame interpolation process from the frame image I1-2 and the frame image I1-3.

Furthermore, with reference to the look-up table 23, the image generation circuit 24 generates a frame image I2-1 of the second image from the interpolated image I1-12 and generates a frame image I2-2 of the second image from the interpolated image I1-23. More specifically, the image generation circuit 24 finds a luminance tone value of each pixel of the interpolated image I1-12 from among the luminance tone values Di of the look-up table 23 and determines a corresponding one of the luminance tone values D2. The frame image I2-1 of the second image is obtained by determining corresponding luminance tone values D2 for all pixels of the frame image I2-1 of the second image.

The data selector 25 receives the data for the first image and the data for the second image from the image generation circuit 24 and generates an image signal in which the data for the first image and the data for the second image are alternately contained for each frame. The image signal thus generated is outputted to the display panel driving circuit 16. Further, the data selector 25 generates a start signal and outputs it to the display panel driving circuit 16.

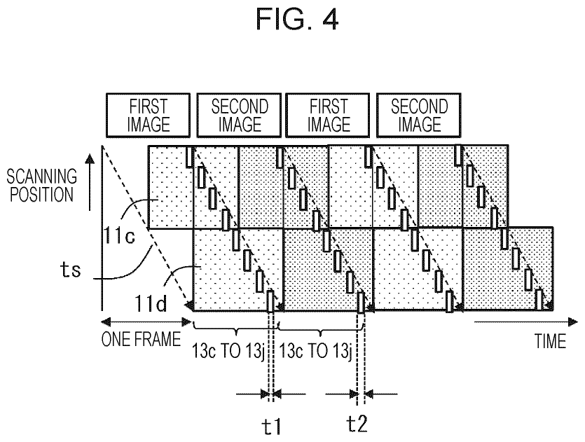

The following describes display of an image on the polarized display panel 10 by the control unit 20. FIG. 4 is a schematic view showing a state of polarization of the polarizing module 11, display of images on the liquid crystal display panel 12, and timings of turning on of the backlight 13. In FIG. 4, the horizontal axis represents time, and the vertical axis represents position in the direction of scanning of the scanning lines of the polarized display panel 10.

As shown in FIG. 4, the first image and the second image are alternately displayed for each frame on the liquid crystal display panel 12. Display of the images in each frame is performed every one scanning line by scanning the scanning lines from top to bottom of the liquid crystal display panel 12 as indicated by a dashed arrow ts. When the TFT of a pixel connected to a scanning line is turned on, a voltage corresponding to a tone value of the data for the first image or the data for the second image is applied from the data line to the pixel electrode via the TFT. This causes a voltage corresponding to the tone value to be applied to the pixel electrode, bringing a liquid crystal layer into a state of alignment corresponding to the tone value. Each pixel displays an image of the previous frame until the scanning line is scanned. For this reason, the first image or the second image to be displayed in each frame is completed at a timing when the scanning of the scanning line is completed.

In a case where the display panel 14 is a liquid crystal display panel, it may take time to reach a state of alignment of liquid crystals that corresponds to the value of a voltage applied to a pixel electrode, as the display response speed is low as mentioned earlier. In this case, when the backlight 13 is turned on as a whole at a time, a difference between the time from the timing of the application of a voltage to the pixel electrode of a pixel scanned first and located in an upper part of the display panel 14 to the turning on of the backlight 13 and the time from the timing of the application of a voltage to the pixel electrode of a pixel scanned last and located in a lower part of the display panel 14 to the turning on of the backlight 13 is made during a one-frame period. For this reason, even if voltages of the same value are applied to the pixel electrodes so that the same luminance tone value is attained, the two pixels differ in luminance from each other and cause luminance unevenness all over the screen 12a.

In the present embodiment, such luminance unevenness is suppressed by dividing the backlight 13 into areas 13c to 13j in the scanning direction and sequentially turning on the areas thus divided after a certain period of time has elapsed since scanning lines situated in the corresponding locations were scanned. This makes it possible to equalize as much as possible the time from the timing of the application of a voltage to the pixel electrode of a pixel connected to one scanning line to the turning on of the backlight 13 and the time from the timing of the application of a voltage to the pixel electrode of a pixel connected to another scanning line to the turning on of the backlight 13, making it possible to suppress luminance unevenness all over the screen 12a.

The length of a first period t1 during which each of the areas 13c to 13j glows for the first image to be displayed may be equal to or different from the length of a second period t2 during which each of the areas 13c to 13j glows for the second image to be displayed. Further, the first period t1 and/or the second period t2 may vary from one of the areas 13c to 13j to another. In a case where the luminance of the backlight 13 is unchanged, making the length of the first period t1 and the length of the second period t2 different from each other allows the backlight 13 to emit different amounts of light that vary between the period during which to display the first image and the period during which to display the second image.

For a similar reason, in a case where the polarizing module 11 is constituted by liquid crystal cells, there occur luminance unevenness and crosstalk between the first image and the second image if the time from the timing of the switching of the state of polarization between the first state of polarization and the second state of polarization to the turning on of the backlight 13 varies according to the position of the polarizing module 11. For this reason, in the present embodiment, in the area 11c of the polarizing module 11, for example, the state of polarization is switched at a timing when scanning of an upper half of scanning lines is completed, and in the area 11d, the state of polarization is switched at a timing when scanning of a lower half of scanning lines is completed. The polarizing module 11 is controlled in accordance with the synchronization signal so as to be in the first state of polarization during the first period during which the backlight 13 glows and be in the second state of polarization during the second period during which the backlight 13 glows.

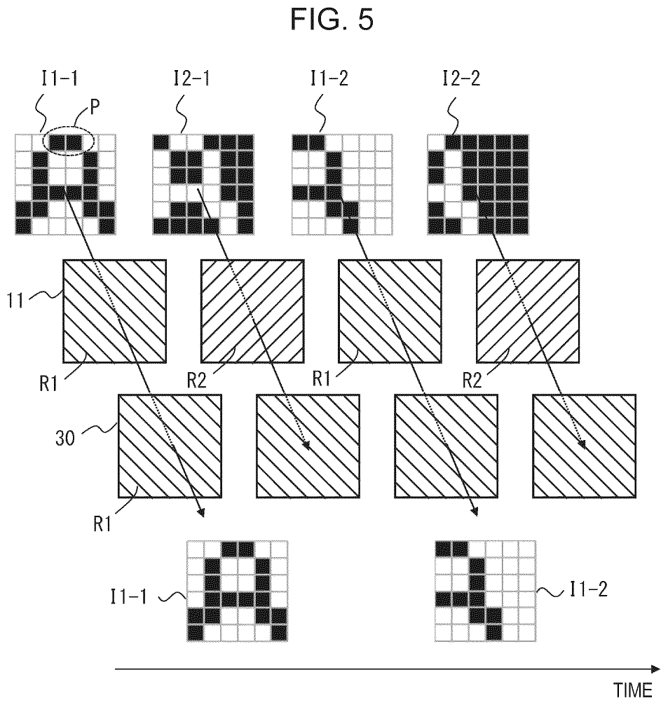

Next, overall operation of the display system 101 is described with reference to FIGS. 5, 6, 7A, and 7B. FIG. 5 is a schematic view explaining an image that the first viewer visually recognizes. The display panel 14 alternately displays a frame image of the first image and a frame image of the second image by time division. For example, the frame image I1-1 of the first image, the frame image of I2-1 of the second image, the frame image I1-2 of the first image, and the frame image I2-1 of the second image are displayed in sequence. As mentioned above, the polarizing module 11 is in a first state of polarization R1 during a period of display of the frame images I1-1 and I1-2 of the first image and is in a second state of polarization R2 during a period of display of the frame images I2-1 and I2-2 of the second image in synchronization with a timing of the time division.

Since the first viewer is wearing the glasses 30 on which a polarizing plate is placed in the first state of polarization R1, an image of the display panel 14 reaches the eyes of the first viewer through the glasses 30 only when there is an agreement in state of polarization. In the present embodiment, the frame images I2-1 and I2-2 of the second image do not pass through the glasses 30 since there is no agreement in state of polarization, and only the frame images I1-1 and I1-2 of the first image in the first state of polarization reach the first viewer. This causes the first viewer to visually recognize the frame images I1-1 and I1-2 of the first image. This causes the first viewer to recognize a moving image of the letter “A” of the alphabet being scrolled leftward.

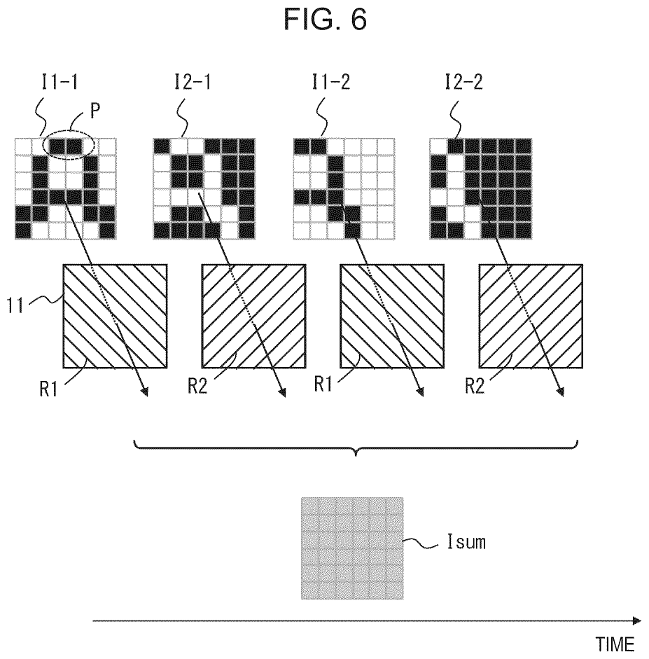

FIG. 6 is a schematic view explaining an image that the second viewer visually recognizes. The display panel 14 and the polarizing module 11 operate in the same manner as in the case of the first viewer.

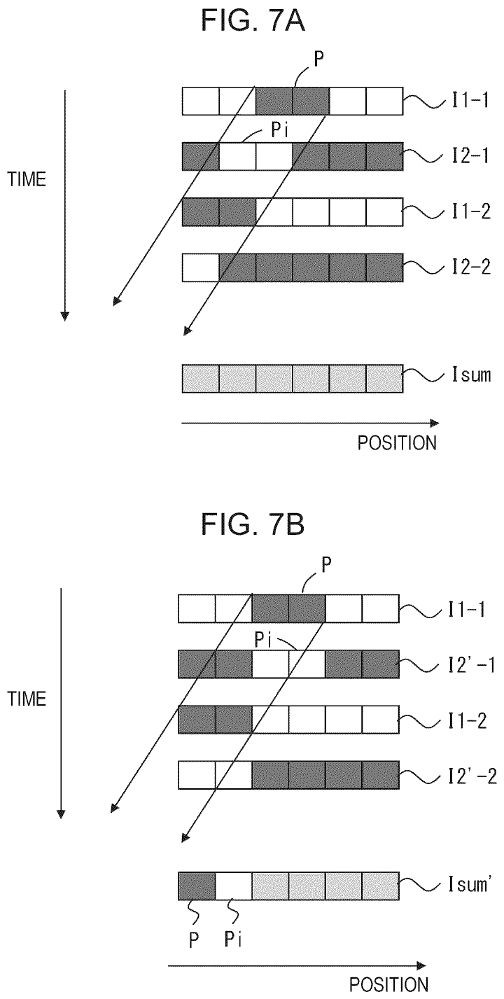

Since the second viewer is not wearing the glasses 30, the frame images I1-1 and I1-2 of the first image in the first state of polarization and the frame images I2-1 and I2-2 of the second image in the second state of polarization reach the second viewer. FIG. 7A is a schematic view obtained by extracting first rows of pixels from the frame images of the first image and the second image that reach the second viewer and longitudinally arranging them on top of each other along a time axis. A portion P of the frame image I1-1 of FIG. 5 shifts leftward in the frame image I1-2. The second viewer's line of sight tracks the portion P as indicated by solid arrows.

The frame image I2-1 of the second image is a reverse image of a frame interpolated image of the frame images I1-1 and I1-2 and therefore includes a portion Pi constituted by a reverse color of the portion P, and the portion Pi is placed on a path of movement of the portion P. For this reason, the frame images I1-1 and I1-2 are canceled out by the frame images I2-1 and I2-2, so that the second viewer visually recognizes an image Isum of a uniform neutral color.

On the other hand, in a case where frame images I2′-1 and I2′-2 of the second image are reverse images obtained directly from the frame images I1-1 and I1-2 of the first image, a portion Pi′ constituted by a reverse color of the portion P partially deviates from the path of movement of the portion P as shown in FIG. 7B; therefore, the frame images I1-1 and I1-2 are not completely canceled out by the frame images I2-1 and I2-2, with the result that the second viewer recognizes an image Isum′ including part of the portion P and part of the portion Pi′. That is, the second viewer can recognize the secret image.

Thus, according to the present embodiment, an interpolated image is generated by a frame interpolation process from two consecutive frames of data for a first image serving as a secret image, and from the interpolated image thus generated, a second image serving as a revere image of the interpolated image is generated. This causes the first image to be appropriately canceled out by the second image even when the first image is a moving image, making it possible to restrain the secret image from being recognized by a third party.

### Second Embodiment

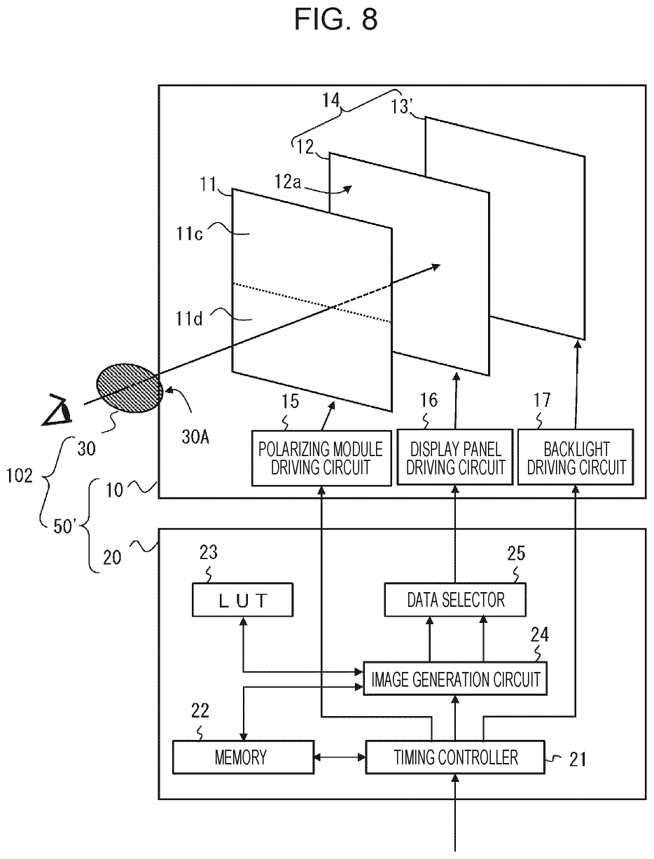

FIG. 8 is a schematic configuration diagram of a display device 50′ and a display system 102 of the present embodiment. The display system 102 differs from the display device 50 and the display system 101 in that the display system 102 includes a backlight 13′ that is integrally turned on and turned off as a whole.

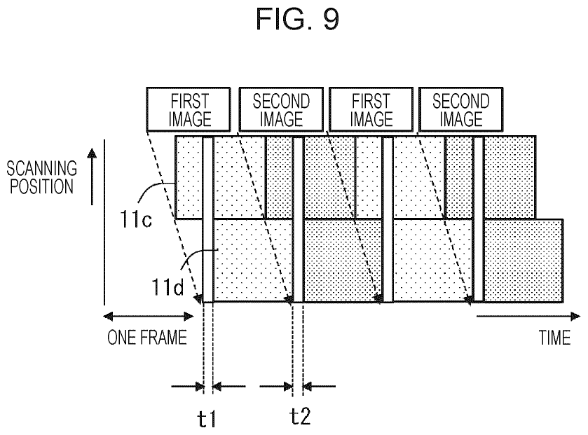

FIG. 9 is a schematic view showing a state of polarization of the polarizing module 11, display of images on the liquid crystal display panel 12, and timings of turning on of the backlight 13′. In FIG. 9, the horizontal axis represents time, and the vertical axis represents position in the direction of scanning of the scanning lines of the polarized display panel 10.

As shown in FIG. 9, the backlight 13′ glows all at once after, in each frame, scanning of the scanning lines has ended and display of the first image or the second image has been completed. During a period of glowing of the backlight 13′, the first image and the second image are alternately displayed for each frame on the liquid crystal display panel 12. Display of the images in each frame is performed every one scanning line by scanning the scanning lines as indicated by a dashed arrow ts. When the TFT of a pixel connected to a scanning line is turned on, a voltage corresponding to a tone value of the data for the first image or the data for the second image is applied from the data line to the pixel electrode via the TFT. This causes a voltage corresponding to the tone value to be applied to the pixel electrode, bringing a liquid crystal layer into a state of alignment corresponding to the tone value. Each pixel displays an image of the previous frame until the scanning line is scanned. For this reason, the first image or the second image to be displayed in each frame is completed at a timing when the scanning of the scanning line is completed. After completion of the display of the first image, the backlight 13′ glows for the first period t1, and after completion of the display of the second image, the backlight 13′ glows for the second period t2. As in the case of the first embodiment, using the backlight 13′ thus driven makes it possible to, even when the secret image is a moving image, restrain the secret image from being recognized by the second viewer.

### Other Embodiments

A display device and a display system of the present embodiment can be altered in various ways without being limited to the foregoing embodiments. Further, as mentioned above, the display device is not limited to a liquid crystal display device but may be an organic EL display device, a mini-LED display device, or other devices.

Further, in the foregoing embodiment, the amount of light from the backlight 13 during display of the first image and the amount of light from the backlight 13 during display of the second image are made equal to each other by making the length of the first period t1 during which to display the first image and the length of the second period t2 during which to display the second image equal to each other. Alternatively, the amounts of light may be made equal to each other by varying both the length of a period of glowing of the backlight 13 and the luminance of the backlight 13 between the first period t1 and the second period t2. For example, the amount of light that is emitted by the backlight 13 during the first period t1 and the amount of light that is emitted by the backlight 13 during the second period t2 may be made equal to each other by setting the first period t1 relatively longer than the second period t2 and setting the luminance of the backlight 13 during the first period t1 relatively lower than the luminance of the backlight 13 during the second period t2. Since the response characteristics of the liquid crystal display panel 12 and the polarizing module 11 are functions of time, the luminance of an image that is displayed on the liquid crystal display panel 12 can be further stabilized by appropriately adjusting the lengths of the first period t1 and the second period t2.

A display device and a display system of the present disclosure can also be described in the following manner.

A display device according to a first configuration is a display device including a display panel, a polarizing module placed over a screen of the display panel and configured to actively switch between causing light emitted from the screen of the display panel to be transmitted in a first state of polarization and causing the light to be transmitted in a second state of polarization, and a control unit. The control unit receives data for a first image from an outside source. The control unit sequentially generates an interpolated image by a frame interpolation process from two consecutive frames of the data for the first image and, from the interpolated image thus generated, generates an reverse image of the interpolated image as a second image. The control unit causes the first image and the second image to be displayed by time division. The control unit controls the polarizing module so that a state of polarization of the polarizing module is the first state of polarization during a period of display of the first image and is the second state of polarization during a period of display of the second image in synchronization with a timing of the time division.

According to the first configuration, an interpolated image is generated by a frame interpolation process from two frames of data for a first image serving as a secret image, and from the interpolated image thus generated, a second image serving as a reverse image of the interpolated image is generated. For this reason, even when the first image is a moving image, the second image is placed in a position followed by a line of sight, and due to a time integration effect of vision, the first image and the second image are combined, so that a second viewer visually recognizes a uniform grayscale screen. This makes it possible to restrain the secret image from being recognized by the viewer.

A display device according to a second configuration may be directed to the first configuration, wherein the first state of polarization and the second state of polarization are linear polarizations whose transmission axes are orthogonal to each other.

A display device according to a third configuration may be directed to the first configuration, wherein the first state of polarization and the second state of polarization are circular polarizations one of which is a right-handed circular polarization and the other of which is a left-handed circularly polarization.

A display device according to a fourth configuration may be directed to the first configuration, wherein the control unit includes a look-up table and an image generation circuit, and the image generation circuit generates data for the interpolated image from the data for the first image and generates data for the second image with reference to the look-up table from the data for the interpolated image.

A display device according to a fifth configuration may be directed to the fourth configuration, wherein the look-up table includes a data set in which luminance tone values of the second image are associated with luminance tone values of the first image.

A display device according to a sixth configuration may be directed to the fifth configuration, wherein the control unit includes a plurality of the look-up tables, and the plurality of look-up tables are created based on measurements performed at different temperatures.

A display system according to a seventh configuration includes the display device according to any one of the first to sixth configurations and glasses on which a polarizing plate is placed in the first state of polarization.

A display system according to an eighth configuration may be directed to the eleventh configuration, wherein a first viewer visually recognizes the first image by viewing the screen of the display panel via the polarizing module and the glasses, the first image being a secret image, and by viewing the screen via the polarizing module, a second viewer who does not wear the glasses visually recognizes, as the public image, a composite image made up of the first image and the second image.

The present disclosure contains subject matter related to that disclosed in Japanese Priority Patent Application JP 2024-077142 filed in the Japan Patent Office on May 10, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display panel;
a polarizing module placed over a screen of the display panel and configured to actively switch between causing light emitted from the screen of the display panel to be transmitted in a first state of polarization and causing the light to be transmitted in a second state of polarization; and
a control unit,
wherein
the control unit sequentially receives data for a first image from an outside source,
the control unit sequentially generates an interpolated image by a frame interpolation process from two consecutive frames of the data for the first image and, from the interpolated image thus generated, generates an reverse image of the interpolated image as a second image,
the control unit causes the first image and the second image to be displayed by time division, and
the control unit controls the polarizing module so that a state of polarization of the polarizing module is the first state of polarization during a period of display of the first image and is the second state of polarization during a period of display of the second image in synchronization with a timing of the time division.

2. The display device according to claim 1, wherein the first state of polarization and the second state of polarization are linear polarizations whose transmission axes are orthogonal to each other.

3. The display device according to claim 1, wherein the first state of polarization and the second state of polarization are circular polarizations one of which is a right-handed circular polarization and the other of which is a left-handed circularly polarization.

4. The display device according to claim 1, wherein
the control unit includes a look-up table and an image generation circuit, and
the image generation circuit generates data for the interpolated image from the data for the first image and generates data for the second image with reference to the look-up table from the data for the interpolated image.

5. The display device according to claim 4, wherein the look-up table includes a data set in which luminance tone values of the second image are associated with luminance tone values of the first image.

6. The display device according to claim 5, wherein
the control unit includes a plurality of the look-up tables, and
the plurality of look-up tables are created based on measurements performed at different temperatures.

7. A display system comprising:
the display device according to claim 1; and
glasses on which a polarizing plate is placed in the first state of polarization.

8. The display system according to claim 7, wherein
a first viewer visually recognizes the first image by viewing the screen of the display panel via the polarizing module and the glasses, the first image being a secret image, and
by viewing the screen via the polarizing module, a second viewer who does not wear the glasses visually recognizes, as the public image, a composite image made up of the first image and the second image.
